(19) United States
(12) Patent Application Publication
(10) Pub. No.: US 2015/0239414 A1
(43) Pub. Date: Aug. 27, 2015

(54) SYSTEM AND METHOD FOR DETERMINING A POSITION OF A VEHICLE SEAT COMPONENT

(71) Applicant: JOHNSON CONTROLS TECHNOLOGY COMPANY, Holland, MI (US)

(72) Inventors: Michael John Thomas, Ann Arbor, MI (US); Eric B. Michalak, Northville, MI (US)

(21) Appl. No.: 14/426,947

(22) PCT Filed: Sep. 9, 2013
(86) PCT No.: PCT/US13/58739

§ 371 Date: Mar. 9, 2015

Related U.S. Application Data
(60) Provisional application No. 61/699,112, filed on Sep. 10, 2012.

(51) Int. Cl. B60R 21/015; G06K 7/10; B60N 2/427; B60N 2/02; B60N 2/42; B60N 2/48

(52) U.S. Cl. CPC B60R 21/01554; B60N 2/4228; B60N 2/4885; B60N 2/42718; B60N 2/0276; G06K 7/10366; B60R 2021/01211

(57) ABSTRACT

A position detection system for a vehicle seat component includes a radio frequency identification (RFID) tag coupled to the vehicle seat component. The position detection system also includes an RFID reader configured to transmit an interrogation signal to the RFID tag, and to receive a return signal from the RFID tag. The position detection system further includes a controller communicatively coupled to the RFID reader. The controller is configured to determine a position of the vehicle seat component based on the interrogation signal and/or the return signal.

### CROSS REFERENCE TO RELATED APPLICATION

This application claims priority from and the benefit of U.S. Provisional Patent Application Ser. No. 61/699,112, entitled “SYSTEM AND METHOD FOR DETERMINING A POSITION OF A VEHICLE SEAT COMPONENT”, filed Sep. 10, 2012, which is hereby incorporated by reference in its entirety.

### BACKGROUND

The invention relates generally to a system and method for determining a position of a vehicle seat component.

Certain vehicle seats include various adjustable components that may be positioned to facilitate passenger comfort and/or to support the passenger during a high g-force event, such as an impact. In addition, a longitudinal position of the vehicle seat may be adjustable to establish a desired occupant position. Certain vehicle seating systems include a position detection mechanism configured to monitor the position of the vehicle seat components and/or the longitudinal position of the vehicle seat. For example, the position detection mechanism may be configured to store the position of each vehicle seat component and/or the longitudinal position of the seat to enable an occupant to automatically return the seat to a desired position. In addition, the position detection mechanism may be configured to automatically adjust deployment parameters of an airbag based on the proximity of the vehicle seat to the instrument panel.

Certain position detection mechanisms include Hall-effect sensors built into the motors that adjust the position of the seat and/or the seat components. Each Hall-effect sensor monitors the rotation of a respective motor, thereby enabling the position detection mechanism to determine the position of each seat component. In addition, certain position detection mechanisms may be configured to detect the longitudinal position of a vehicle seat by measuring an interaction between a magnetic field and a metallic blade coupled to the vehicle seat. Unfortunately, such position detection mechanisms may significantly increase the complexity, weight, and cost of the vehicle seating system.

### BRIEF DESCRIPTION OF THE INVENTION

The present invention relates to a position detection system for a vehicle seat component. The position detection system includes a radio frequency identification (RFID) tag coupled to the vehicle seat component. The position detection system also includes an RFID reader configured to transmit an interrogation signal to the RFID tag, and to receive a return signal from the RFID tag. The position detection system further includes a controller communicatively coupled to the RFID reader. The controller is configured to determine a position of the vehicle seat component based on the interrogation signal and/or the return signal.

The present invention also relates to a position detection system for a vehicle seat component including a controller. The controller is configured to instruct a radio frequency identification (RFID) reader to transmit an interrogation signal to an RFID tag coupled to the vehicle seat component, to receive a return signal from the RFID tag via the RFID reader, and to determine a position of the vehicle seat component based on the interrogation signal and/or the return signal.

The present invention further relates to a method for determining a position of a vehicle seat component. The method includes transmitting an interrogation signal to a radio frequency identification (RFID) tag coupled to the vehicle seat component. The method also includes receiving a return signal from the RFID tag, and determining a position of the vehicle seat component based on the interrogation signal and/or the return signal.

### DRAWINGS

FIG. 1 is a perspective view of an exemplary vehicle that may include a radio frequency identification (RFID) system configured to determine a position of a vehicle seat component.

FIG. 2 is a perspective view of a vehicle seat and an embodiment of an RFID system configured to determine respective positions of various components of the vehicle seat.

FIG. 3 is a side view of a vehicle seat and an embodiment of an RFID system configured to determine a longitudinal position of the seat.

FIG. 4 is a side view of a seat bottom cushion and an embodiment of an RFID system configured to measure compression of the seat bottom cushion.

FIG. 5 is a side view of a headrest and an embodiment of an RFID system configured to determine a position of the headrest.

FIG. 6 is a side view of a seat bottom and an embodiment of an RFID system configured to determine a position of an antisubmarine device.

FIG. 7 is a flow diagram of an embodiment of a method for determining a position of a vehicle seat component using an RFID system.

### DETAILED DESCRIPTION

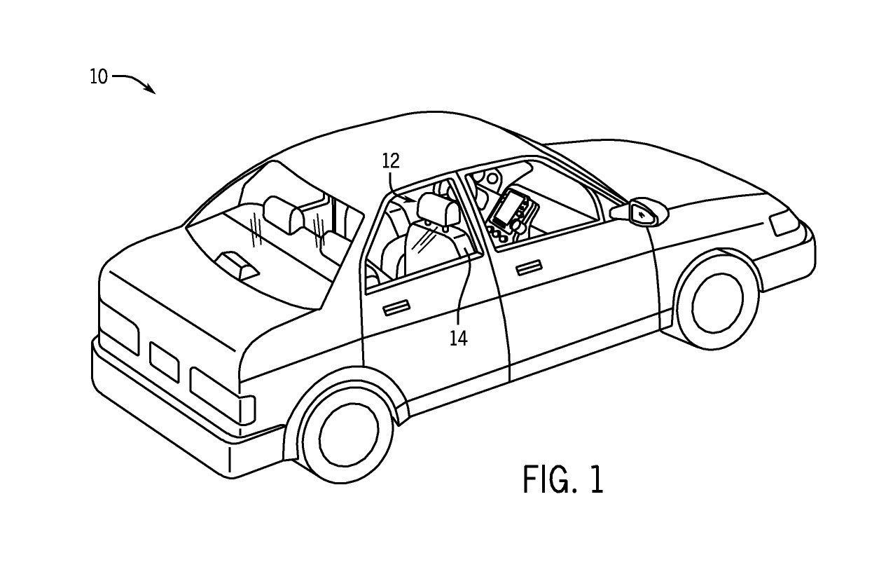

FIG. 1 is a perspective view of an exemplary vehicle 10 that may include a radio frequency identification (RFID) system configured to determine a position of a vehicle seat component. As illustrated, the vehicle 10 includes an interior 12 having a seat 14. As discussed in detail below, the RFID position detection system includes multiple RFID tags coupled to various components of the vehicle seat 14. The RFID position detection system also includes an RFID reader configured to transmit an interrogation signal to the RFID tags, and to receive respective return signals from the RFID tags. In addition, the RFID position detection system includes a controller communicatively coupled to the RFID reader. The controller is configured to determine a position of each vehicle seat component based on the interrogation signal and/or the return signals. For example, the controller may be configured to determine the position of a vehicle seat component based on a magnitude of a return signal from an RFID tag coupled to the component. In addition, the controller may be configured to determine the position of a vehicle seat component by instructing the RFID reader to progressively increase a magnitude of the interrogation signal until the RFID reader receives a return signal. The controller may then determine the position of the vehicle seat component based on the magnitude of the interrogation signal associated with reception of the return signal.

Because RFID tags may be coupled to various components of the vehicle seat for identification purposes, installation of separate sensors may be obviated. Accordingly, the installation costs and the complexity of the RFID position detection system may be significantly less than a position detection system that employs wired sensors (e.g., Hall-effect sensors, magnetic sensors, etc.). In addition, a single RFID reader may be employed to determine the position of multiple RFID tags, thereby further reducing the costs and the complexity of the position detection system.

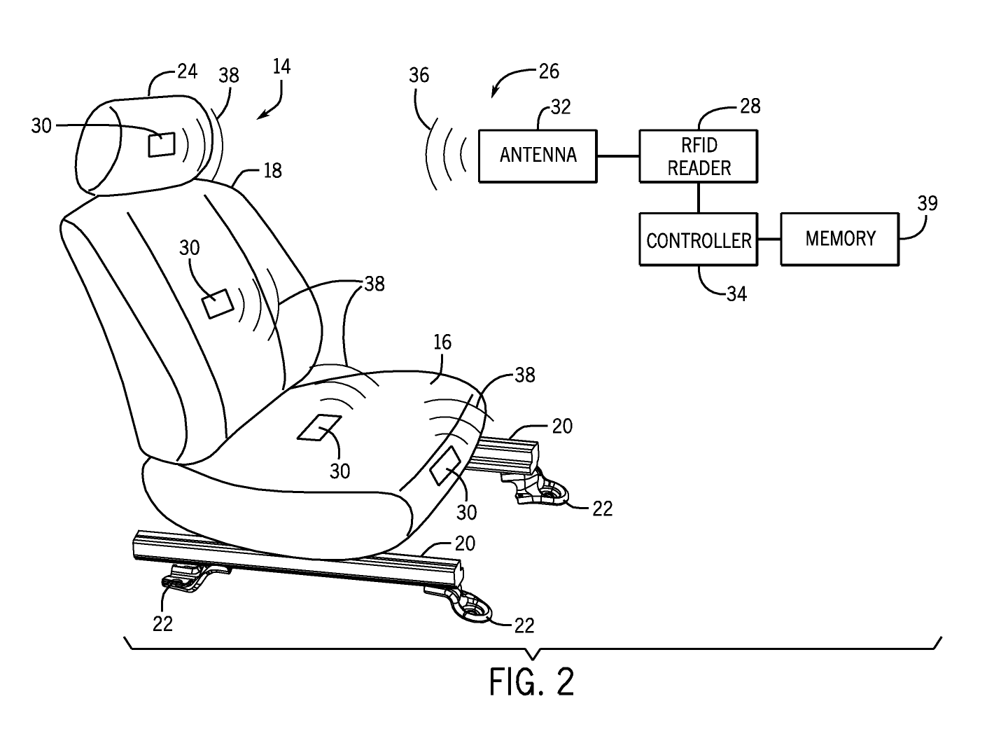

FIG. 2 is a perspective view of a vehicle seat 14 and an embodiment of an RFID system configured to determine respective positions of various components of the vehicle seat. As illustrated, the seat 14 includes a seat bottom 16 and a seat back 18. In certain embodiments, the seat bottom 16 may include a seat bottom chassis, one or more cushions, and a fabric covering. The seat bottom chassis serves to support the weight of a passenger during normal vehicle operation and during high g-force events (e.g., rapid acceleration or deceleration, etc.). The seat bottom chassis also secures the seat bottom 16 to a floor of the vehicle 10, and provides a mounting surface for the seat back 18. One or more cushions may be coupled to the seat bottom chassis to provide passenger comfort, and the fabric covering may be disposed about the assembly to provide a desired appearance and/or to protect the internal components of the seat bottom 16. The seat back 18 may be constructed in a similar manner, i.e., from one or more cushions secured to a rigid chassis and wrapped with a fabric covering.

As illustrated, the seat bottom 16 is secured to a seat track 20. The seat track 20, in turn, is secured to the floor of the vehicle 10 by mounting feet 22. In certain configurations, the seat 14 may be configured to translate along the seat track 20 to adjust a longitudinal position of a driver or passenger. As will be appreciated, adjustment of the seating position may be either manual or assisted. For example, an electric motor may be configured to drive the seat 14 along the track 20 by a suitable mechanism such as a rack and pinion system. In addition, the seat back 18 may be configured to recline with respect to the seat bottom 16. Adjustment of the seat back 18 may also be either manual or assisted by an electric motor, for example.

In the illustrated embodiment, the vehicle seat 14 includes a headrest 24 coupled to the seat back 18. The height and/or orientation of the headrest 24 may be adjustable relative to the seat back 18 to facilitate passenger comfort. In addition, as discussed in detail below, the vehicle seat 14 may include an active head restraint system configured to rotate the headrest 24 forwardly during a rear impact, thereby supporting the occupant head.

In the illustrated embodiment, an RFID position detection system 26 is employed to determine respective positions of various components of the vehicle seat 14. The position detection system 26 includes an RFID reader 28 configured to communicate with multiple RFID tags 30 coupled to certain vehicle seat components. As illustrated, the RFID reader 28 is communicatively coupled to an antenna 32 and a controller 34. The RFID reader 28 is configured to transmit an interrogation signal 36 to the RFID tags 30 via the antenna 32. In addition, the RFID reader 28 is configured to receive a return signal 38 from each RFID tag 30 through the antenna 32. The controller 34 is configured to determine a position of each RFID tag 30 based on the interrogation signal 36 and/or the return signal 38, thereby determining the position of each respective seat component.

In certain embodiments, the controller 34 is configured to determine the position of a vehicle seat component based on a magnitude of the return signal 38 from the RFID tag 30. For example, a stronger return signal may indicate that the RFID tag 30 is closer to the antenna 32, and a weaker return signal may indicate that the RFID tag 30 is farther from the antenna 32. In certain embodiments, the controller 34 is communicatively coupled to a memory 39 that provides data (e.g., table, algorithm, etc.) to the controller 34 indicative of a magnitude/distance relationship. Accordingly, the controller 34 may determine a relative distance between the antenna 32 and the RFID tag 30 based on the magnitude of the return signal 38 and the magnitude/distance relationship data.

In further embodiments, the controller 34 is configured to determine the position of the vehicle seat component by instructing the RFID reader 28 to progressively increase a magnitude of the interrogation signal 36 until the RFID reader 28 receives a return signal 38. For example, the controller 34 may instruct the RFID reader 28 to transmit an interrogation signal 36 of a first magnitude, and wait a predetermined interval for a return signal 38. If no return signal 38 is received, the controller 34 may instruct the RFID reader 28 to transmit a second interrogation signal 36 of a second magnitude, greater than the first magnitude, and wait the predetermined internal for the return signal 38. This process may repeat until a return signal 38 is received, at which point the controller 34 may determine the position of the vehicle seat component based on the magnitude of the interrogation signal 36 associated with reception of the return signal 38. In certain embodiments, the memory 39 may provide data (e.g., table, algorithm, etc.) to the controller 34 indicative of a magnitude/distance relationship. Accordingly, the controller 34 may determine a relative distance between the antenna 32 and the RFID tag 30 based on the magnitude of the interrogation signal 36 and the magnitude/distance relationship data.

In the illustrated embodiment, a first RFID tag 30 is coupled to a front portion of the seat bottom 16. The position detection system 26 is configured to determine a position of the seat bottom 16 along a longitudinal axis of the vehicle by determining a distance between the antenna 32 and the first RFID tag 30.

Furthermore, a second RFID tag 30 is coupled to the seat back 18. The position detection system 26 is also configured to determine a position of the seat back 18 relative to the seat bottom 16 by comparing respective distances of the first and second RFID tags. Accordingly, the position detection system 26 may determine a recline angle of the seat back 18 based on the relative positions of the first and second RFID tags. In addition, the position detection system 26 is configured to determine a rotation angle of the headrest 24 by comparing a position of a third RFID tag 30, which is coupled to the headrest 24, to the position of the second RFID tag 30. In certain embodiments, the position detection system 26 may be configured to store the position of each vehicle seat component and/or the longitudinal position of the seat in the memory 39 to enable an occupant to automatically return the seat to a desired position. In addition, as discussed in detail below, the position detection system 26 may be configured to automatically adjust deployment parameters of an airbag based on the proximity of the vehicle seat to the instrument panel.

Furthermore, an RFID tag 30 is coupled to an upper surface of the seat bottom cushion to facilitate determination of a load applied to the seat bottom 16 (e.g., due to the weight of a seat occupant). The controller 34 is configured to measure compression of the seat bottom cushion based on the position of the upper surface of the seat bottom cushion relative to the seat bottom chassis. For example, while the seat bottom cushion is in an uncompressed state, the controller 34 may store the position of the RFID tag 30 in the memory 39. After the seat bottom cushion is compressed, the controller 34 may compare the position of the RFID tag 30 to the position stored in the memory 39, thereby enabling the controller 34 to determine the compression of the seat bottom cushion. In certain embodiments, the memory 39 may provide data (e.g., table, algorithm, etc.) to the controller 34 indicative of a compression/weight relationship. Accordingly, the controller 34 may determine the occupant weight based on the compression of the seat bottom cushion and the compression/weight relationship data. As discussed in detail below, the controller 34 may be configured to adjust deployment parameters of an airbag based on the weight applied to the seat bottom cushion.

In the illustrated embodiment, each RFID tag 30 is configured to communicate with a single antenna 32 and RFID reader 28. However, it should be appreciated that alternative embodiments may employ additional antennas 32 and/or RFID readers 28 to facilitate communication with respective RFID tags 30. In certain embodiments, each RFID tag 30 may be configured to include a unique code in the return signal 38 to facilitate identification of each RFID tag 30. In such embodiments, the unique code corresponding to each seat component may be stored in the memory 39, thereby enabling the controller 34 to associate movement of an RFID tag 30 with a particular seat component. In certain embodiments, each RFID tag 30 may be powered by the interrogation signal 36, thereby obviating a separate power source (e.g., a battery disposed within the RFID tag housing). Such embodiments may enhance longevity and/or reduce the cost of the RFID tags.

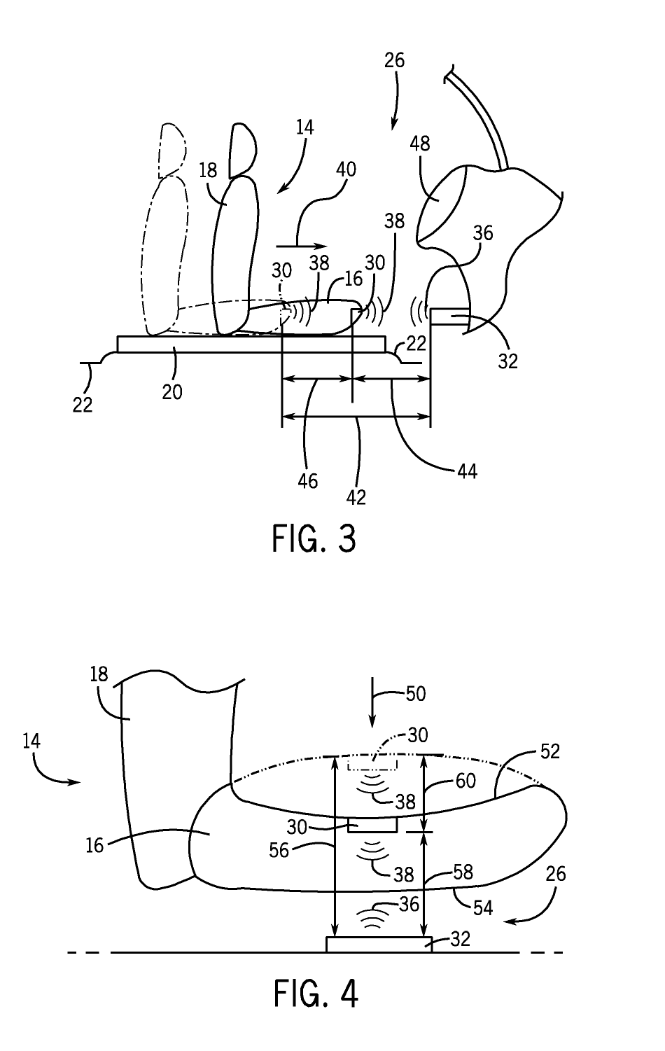

FIG. 3 is a side view of a vehicle seat 14 and an embodiment of an RFID position detection system 26 configured to determine a longitudinal position of the seat 14. In the illustrated embodiment, the vehicle seat 14 is configured to translate along the track 20 to adjust a longitudinal position (e.g., position along a longitudinal axis of the vehicle 10) of a driver or passenger. For example, the seat 14 may be translated in a longitudinally forward direction 40 from a first position (phantom line) to a second position (solid line). As illustrated, while the seat 14 is in the first position, an RFID tag 30 coupled to the seat bottom 16 is positioned a first distance 42 from the RFID antenna 32. Once the seat 14 is translated to the second position, the RFID tag 30 is positioned a second distance 44 from the antenna 32. As previously discussed, the controller is configured to determine the first and second distances based on the interrogation signal 36 and/or the return signal 38. In the present embodiment, the controller is also configured to determine the longitudinal displacement 46 of the seat 14 by comparing the first distance 42 and the second distance 44. Accordingly, the RFID position detection system 26 may determine the position of the seat 14 along the longitudinal axis of the vehicle.

Furthermore, the controller may be configured to adjust deployment parameters of an airbag 48 based on the position of the vehicle seat 14 relative to the airbag. For example, the controller may be configured to reduce the deployment speed and/or the force of the airbag if the distance between the seat and the airbag is less than a first threshold value. In addition, the controller may be configured to disable the airbag if the distance between the seat and the airbag is less than a second threshold value. In further embodiments, the controller may incrementally and/or continuously vary the deployment speed and/or force based on the distance between the seat 14 and the airbag 48.

FIG. 4 is a side view of a seat bottom cushion and an embodiment of an RFID position detection system 26 configured to measure compression of the seat bottom cushion. In the illustrated embodiment, the seat bottom 16 includes a cushion that compresses when a force is applied in a vertically downward direction 50. The RFID position detection system 26 is configured to determine a magnitude of the downward force based on the compression, thereby enabling the system to determine a weight of a seat occupant. As illustrated, an RFID tag 30 is coupled to an upper surface 52 of the seat bottom cushion. The controller is configured to measure compression of the seat bottom cushion based on the position of the upper surface 52 relative to a seat bottom chassis 54. For example, while the seat bottom cushion is in an uncompressed state (phantom line), the RFID tag 30 is positioned a first distance 56 from the RFID antenna 32. However, when the seat bottom cushion is compressed (solid line), the RFID tag 30 is moved to a second distance 58, which is closer to the antenna 32. By comparing the first and second distances, the controller may determine the distance 60 between the uncompressed state and the compressed state, thereby enabling the controller to determine the weight of the seat occupant.

In addition, the controller may be configured to adjust deployment parameters of the airbag 48 based on the weight of the seat occupant. For example, the controller may be configured to reduce the deployment speed and/or the force of the airbag if the occupant weight is less than a first threshold value. In addition, the controller may be configured to disable the airbag if the occupant weight is less than a second threshold value. In further embodiments, the controller may incrementally and/or continuously vary the deployment speed and/or force based on the weight of the seat occupant.

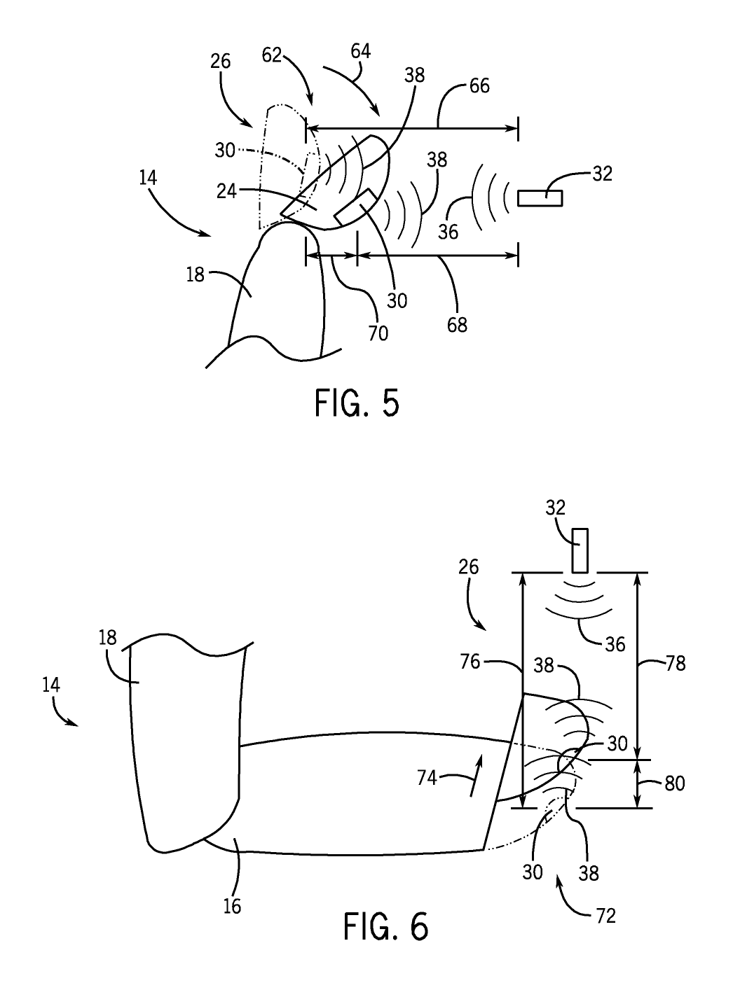

FIG. 5 is a side view of a headrest 24 and an embodiment of an RFID position detection system 26 configured to determine a position of the headrest. In the illustrated embodiment, the vehicle seat 14 includes an active head restraint system 62 configured to rotate the headrest 24 forwardly during a rear impact, thereby supporting the occupant head. For example, during a rear impact, the active head restraint system 62 may rotate the headrest 24 in a forward direction 64 from a first position (phantom line) to a second position (solid line). As illustrated, while the headrest 24 is in the first position, an RFID tag 30 coupled to the headrest 24 is positioned a first distance 66 from the RFID antenna 32. Once the headrest 24 is rotated to the second position, the RFID tag 30 is positioned a second distance 68 from the antenna 32. As previously discussed, the controller is configured to determine the first and second distances based on the interrogation signal 36 and/or the return signal 38. In the present embodiment, the controller is also configured to determine the longitudinal displacement 70 of the headrest 24 by comparing the first distance 66 and the second distance 68. Accordingly, the RFID position detection system 26 may determine a state of the active head restraint system 62 based on the position of the headrest 24.

FIG. 6 is a side view of a seat bottom 16 and an embodiment of an RFID position detection system 26 configured to determine a position of an antisubmarine device. In the illustrated embodiment, the vehicle seat 14 includes an antisubmarine device 72 configured to block forward and/or downward movement of a seat occupant during an impact. For example, during an impact, the antisubmarine device 72 may translate a forward portion of the seat bottom in an upward direction 74 from a first position (phantom line) to a second position (solid line). As illustrated, while the seat bottom portion is in the first position, an RFID tag 30 coupled to the seat bottom 16 is positioned a first distance 76 from the RFID antenna 32. Once the antisubmarine device 72 is deployed, the RFID tag 30 is positioned a second distance 78 from the antenna 32. As previously discussed, the controller is configured to determine the first and second distances based on the interrogation signal 36 and/or the return signal 38. In the present embodiment, the controller is also configured to determine the vertical displacement 80 of the seat bottom portion by comparing the first distance 76 and the second distance 78. Accordingly, the RFID position detection system 26 may determine a state of the antisubmarine device 72 based on the position of the seat bottom portion.

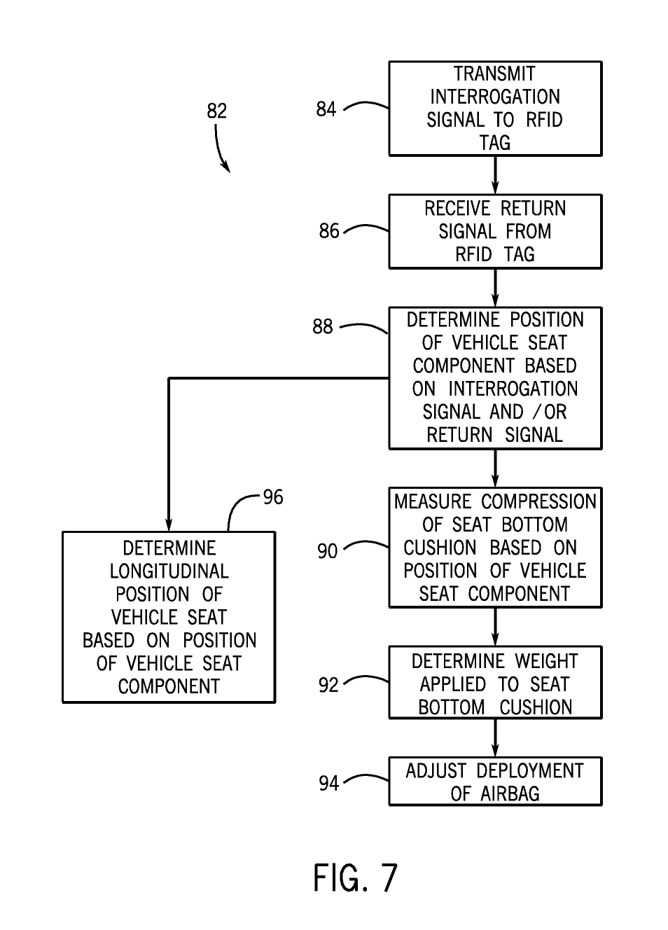

FIG. 7 is a flow diagram of an embodiment of a method 82 for determining a position of a vehicle seat component using an RFID system. First, as represented by block 84, an interrogation signal is transmitted to an RFID tag coupled to a vehicle seat component. A return signal is then received from the RFID tag, as represented by block 86. The position of the vehicle seat component is then determined based on the interrogation signal and/or the return signal, as represented by block 88. As previously discussed, one technique for determining the position of the vehicle seat component includes measuring a magnitude of the return signal, and determining the position of the vehicle seat component based on the return signal magnitude. In addition, the position of the vehicle seat component may be determined by progressively increasing a magnitude of the interrogation signal until reception of the return signal. The position of the vehicle seat component may then be determined based on the magnitude of the interrogation signal associated with reception of the return signal.

In certain embodiments, deployment parameters of an airbag may be adjusted based on the position of the vehicle seat component. For example, an RFID tag may be coupled to an upper surface of a seat bottom cushion, and the position of the upper surface of the seat bottom cushion relative to a seat bottom chassis may be determined. Compression of the seat bottom cushion is then measured based on the position of the upper surface of the seat bottom cushion relative to the seat bottom chassis, as represented by block 90. Next, a weight applied to the seat bottom cushion is determined based on the compression of the seat bottom cushion, as represented by block 92. Deployment parameters of the airbag are then adjusted based on the weight applied to the seat bottom cushion, as represented by block 94.

In further embodiments, a longitudinal position of the vehicle seat may be determined based on the position of the vehicle seat component, as represented by block 96. For example, an RFID tag may be mounted to a seat bottom, and the RFID position detection system may determine the longitudinal position of the seat based on a distance between the RFID antenna and the RFID tag. As previously discussed, airbag deployment parameters may also be adjusted based on the longitudinal position of the seat.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A position detection system for a vehicle seat component, comprising:
a radio frequency identification (RFID) tag coupled to the vehicle seat component;
an RFID reader configured to transmit an interrogation signal to the RFID tag, and to receive a return signal from the RFID tag; and
a controller communicatively coupled to the RFID reader, wherein the controller is configured to determine a position of the vehicle seat component based on the interrogation signal, the return signal, or a combination thereof.

2. The position detection system of claim 1, wherein the controller is configured to determine the position of the vehicle seat component based on a magnitude of the return signal from the RFID tag.

3. The position detection system of claim 1, wherein the controller is configured to determine the position of the vehicle seat component by instructing the RFID reader to progressively increase a magnitude of the interrogation signal until the RFID reader receives the return signal.

4. The position detection system of claim 1, wherein the vehicle seat component comprises an upper surface of a seat bottom cushion, and the controller is configured to measure compression of the seat bottom cushion based on the position of the upper surface of the seat bottom cushion relative to a seat bottom chassis.

5. The position detection system of claim 4, wherein the controller is configured to determine a weight applied to the seat bottom cushion based on the compression of the seat bottom cushion, and to adjust deployment parameters of an airbag based on the weight applied to the seat bottom cushion.

6. The position detection system of claim 1, wherein the vehicle seat component comprises a headrest, and the controller is configured to determine a state of an active head restraint system based on the position of the headrest.

7. The position detection system of claim 1, wherein the vehicle seat component comprises an antisubmarine device, and the controller is configured to determine a state of the antisubmarine device based on the position of the antisubmarine device.

8. The position detection system of claim 1, wherein the vehicle seat component comprises a seat bottom, and the controller is configured to determine the position of the seat bottom along a longitudinal axis of a vehicle.

9. The position detection system of claim 8, wherein the controller is configured to adjust deployment parameters of an airbag based on the position of the seat bottom relative to the airbag.

10. The position detection system of claim 1, comprising a second RFID tag coupled to a second vehicle seat component, wherein the RFID reader is configured to receive a second return signal from the second RFID tag, and the controller is configured to determine a second position of the second vehicle seat component based on the interrogation signal, the second return signal, or a combination thereof.

11. A position detection system for a vehicle seat component, comprising:
a controller configured to instruct a radio frequency identification (RFID) reader to transmit an interrogation signal to an RFID tag coupled to the vehicle seat component, to receive a return signal from the RFID tag via the RFID reader, and to determine a position of the vehicle seat component based on the interrogation signal, the return signal, or a combination thereof.

12. The position detection system of claim 11, wherein the controller is configured to determine the position of the vehicle seat component based on a magnitude of the return signal from the RFID tag.

13. The position detection system of claim 11, wherein the controller is configured to determine the position of the vehicle seat component by instructing the RFID reader to progressively increase a magnitude of the interrogation signal until the RFID reader receives the return signal.

14. The position detection system of claim 11, wherein the vehicle seat component comprises an upper surface of a seat bottom cushion, and the controller is configured to measure compression of the seat bottom cushion based on the position of the upper surface of the seat bottom cushion relative to a seat bottom chassis.

15. The position detection system of claim 11, wherein the vehicle seat component comprises a seat bottom, and the controller is configured to determine the position of the seat bottom along a longitudinal axis of a vehicle.

16. A method for determining a position of a vehicle seat component, comprising:
transmitting an interrogation signal to a radio frequency identification (RFID) tag coupled to the vehicle seat component;
receiving a return signal from the RFID tag; and
determining a position of the vehicle seat component based on the interrogation signal, the return signal, or a combination thereof.

17. The method of claim 16, wherein determining the position of the vehicle seat component comprises measuring a magnitude of the return signal, and determining the position of the vehicle seat component based on the magnitude of the return signal.

18. The method of claim 16, wherein transmitting the interrogation signal comprises progressively increasing a magnitude of the interrogation signal until reception of the return signal, and wherein determining the position of the vehicle seat component is based on the magnitude of the interrogation signal associated with reception of the return signal.

19. The method of claim 16, comprising:
measuring compression of a seat bottom cushion based on the position of the vehicle seat component, wherein the vehicle seat component comprises an upper surface of the seat bottom cushion, and determining the position of the vehicle seat component comprises determining the position of the upper surface of the seat bottom cushion relative to a seat bottom chassis;
determining a weight applied to the seat bottom cushion based on the compression of the seat bottom cushion; and
adjusting deployment parameters of an airbag based on the weight applied to the seat bottom cushion.

20. The method of claim 16, comprising determining a longitudinal position of a vehicle seat based on the position of the vehicle seat component, wherein the vehicle seat component comprises a seat bottom.
